(19) United States
(12) Patent Application Publication
(10) Pub. No.: US 2025/0374285 A1
(43) Pub. Date: Dec. 4, 2025

(54) DEVICE CANDIDATE IDENTIFICATION FOR CONTROL SIGNAL BEAMFORMING

(71) Applicant: T-MOBILE INNOVATIONS LLC, Overland Park, KS (US)

(72) Inventor: Sanghoon SUNG, Ashburn, VA (US)

(21) Appl. No.: 18/677,511

(22) Filed: May 29, 2024

(51) Int. Cl. H04W 72/23; H04B 7/0452; H04B 7/06; H04W 72/121

(52) U.S. Cl. CPC H04W 72/23; H04B 7/0452; H04B 7/0617; H04W 72/121

(57) ABSTRACT

Systems and methods are provided for selecting user equipment (UE) candidates for control signaling using beamformed signals. A spectral efficiency is determined for a first set of signals between a first UE and a base station in a telecommunications network. It is then determined that the spectral efficiency of the first set of signals is above a threshold. Based on the spectral efficiency of the first set of signals being above the threshold, beamforming is utilized for a set of control signals between the first UE and the base station.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for identifying UE candidates for beamforming of control signaling, and more specifically, for multiple-user multiple-input multiple-output (MU-MIMO) for PDCCH. To identify these candidates, it is first determined whether the UE is currently scheduled for beamforming for data transmissions, such as MU-MIMO for PDSCH. If so, the spectral efficiency of the PDSCH transmissions is determined, and if above a predetermined threshold, that UE may be considered as a candidate for MU-MIMO for PDCCH. This process may be performed for multiple UEs so that the UEs can be paired together for MU-MIMO for PDCCH.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed;

FIG. 2 illustrates an exemplary beam management system, in accordance with aspects herein;

FIG. 3 illustrates a flow diagram used to determine whether a device is a candidate for a PDCCH MU-MIMO pairing, in accordance with aspects herein;

FIG. 4 depicts UE selection for PDCCH MU-MIMO pairing, in accordance with aspects herein;

FIG. 5 depicts a flow diagram of a method for selecting UE candidates for control signaling using beamformed signals, in accordance with aspects herein;

FIG. 6 depicts another flow diagram of a method for selecting UE candidates for control signaling using beamformed signals, in accordance with aspects herein; and

FIG. 7 depicts a diagram of an exemplary computing environment suitable for use in implementations of the present disclosure.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. Further, various technical terms are used throughout this description. An illustrative resource that fleshes out various aspects of these terms can be found in Newton's Telecom Dictionary, 32d Edition, 2022.

As used herein, the term “node” is used to refer to network access technology, such as eNode, gNode, etc. In other aspects, the term “node” may be used to refer to one or more antennas being used to communicate with a user device.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of base stations (i.e., cell sites, cell towers) to provide network coverage. The base stations are employed to broadcast and transmit transmissions to user devices of the telecommunications network. An access point may be considered to be a portion of a base station that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, 6G, and the like); however, in other aspects, a single access point may communicate with a UE according to multiple protocols. As used herein, a base station may comprise one access point or more than one access point. Factors that can affect the telecommunications transmission include, e.g., location and size of the base stations, and frequency of the transmission, antenna array configuration corresponding to both the access point and the UE, among other factors. The base stations are employed to broadcast and transmit transmissions to user devices of the telecommunications network.

As employed herein, a UE (also referenced herein as a user device) can include any device employed by an end-user to communicate with a wireless telecommunications network. A UE can include a mobile device, an IoT device, a device connected to an automobile, a mobile broadband adapter, or any other communications device employed to communicate with the wireless telecommunications network. A UE, as one of ordinary skill in the art may appreciate, generally includes one or more antenna coupled to a radio for exchanging (e.g., transmitting and receiving) transmissions with a nearby base station.

In conventional cellular communications technology, beamforming is a signal processing technique that enables a node to send targeted beams of data to users. Not only does this reduce interference, it also makes more efficient use of the frequency spectrum. Physical downlink control channel (PDCCH) is a crucial component in both LTE and 5G communication systems. Its primary role is to deliver control information to UE and other devices within the network. More particularly, PDCCH is a channel used to carry downlink control information (DCI), e.g., downlink scheduling assignments and uplink scheduling grants. For example, the PDCCH provides scheduling allocations to the UE for either the physical downlink shared channel (PDSCH) or the physical uplink shared channel (PUSCH). If the UE has data in the PDSCH, the PDCCH informs the UE where to find that data within the PDSCH.

PDCCH beamforming is a type of beamforming that can extend coverage to users using the same amount of energy. Unlike LTE control channels which occupy the entire system bandwidth, 5G NR PDCCH channels occupy certain subcarriers and OFDM symbols. The channels are transmitted in a configurable control resource set (CORESET). By leveraging a narrower beam, PDCCH beamforming can extend coverage to UEs farther away from the node than with traditional beamforming. However, PDCCH beamforming is currently limited to a single PDCCH per UE. In other words, PDCCH beamforming does not currently support utilizing multiple PDCCHs to provide additional PDCCH capacity to a single UE.

UE may be unable to scan the entire CORESET(s), as it is both power and time consuming plus highly inefficient. Instead, within a CORESET, there are Search Spaces (SS) where PDCCH is located. The UE scans these SSs blindly for PDCCH, which may be termed blind decoding. There are multiple copies of PDCCH within these SSs and they are instead called PDCCH candidates, or candidate PDCCH. A UE may be able to blindly decode any of the PDCCH among these candidates. The number of candidate-PDCCHs depends on something known as Aggregation Level (AL). AL is a sort of link adaptation method for the downlink control channel. The SSs limit the UE's search to a certain time-frequency region within the downlink resource grid. This saves the complexity in searching as well as in UE hardware design.

For background, the basic unit of CORESET is resource element group (REG), which is equal to one resource block (RB) (i.e. 12 REs) in the frequency domain and one symbol in the time domain. The basic unit of PDCCH is a control channel element (CCE). A group of 6 REGs makes one CCE. A PDCCH consists of 1, 2, 4, 6, 8, or 16 CCEs. This is defined based on aggregation level (AL). There is a direct, or one-to-one relationship between AL and the number of CCEs, i.e. AL=1 means 1 CCE, AL=4 means 4 CCEs.

Generally, as the number of radio resource control (RRC) connected UEs increases, more channel resources are allocated for PDCCH. Consequently, channel resource for PDSCH becomes smaller, which results in a decrease of the user data rate. On the other hand, if PDCCH resources are not increased, then downlink (DL) and uplink (UL) data scheduling will be blocked for some users due to PDCCH resource shortage. Even if PDCCH resources are increased to the maximum allowable level, the scheduling blocking may still happen when a quantity of RRC active users exceeds the quantity of users that can be supported by the maximum PDCCH channel resource.

PDCCH candidates to be monitored may be configured for a UE by means of search space (SS) sets. There are two SS set types-common SS (CSS) set, which is commonly monitored by a group of UEs in the cell, and UE-specific SS (USS) set, which is monitored by an individual UE. Said in a different way, a CSS is shared across all UEs, while a USS is used for each UE. Conventionally, methods to improve PDCCH capacity consist of UE-specific beamforming for USS. That is, beamforming gain may reduce the PDCCH PRB size (e.g., from AL 4 to AL 2). Two approaches have conventionally been used for implementation of UE-specific Beamforming, including reciprocity-based UE-specific beamforming using UL channel estimation, and precoder matrix indicator (PMI)-based UE-specific beamforming using UE feedback.

The present disclosure is directed to systems and methods for selecting UE candidates for control signaling using beamformed signals. As described herein, for a UE to be a candidate for control signaling using beamformed signals, it is determined that the UE is currently scheduled for data transmissions using beamforming, and the spectral efficiency of those data transmissions is above a threshold. In aspects, the data transmissions are PDSCH, and the control signaling is PDCCH. Additionally, in aspects, the beamformed signals are formed using MU-MIMO. In some cases, one of the above-stated criteria is met to determine a UE is a candidate for PDCCH using MU-MIMO, but in other cases, both criteria are met. In scenarios when MU-MIMO is used for PDCCH, the UEs are paired together, as they are with PDSCH with MU-MIMO. As described, aspects support orthogonal cover code (OCC) multiplexed to DMRS of PDCCH CCEs. Both time domain OCC and frequency domain OCC may be supported.

Accordingly, a first aspect of the present disclosure is directed to a method for selecting UE candidates for control signaling using beamformed signals. The method comprises determining a spectral efficiency of a first set of signals between a first UE and a base station in a telecommunications network, determining that the spectral efficiency of the first set of signals between the first UE and the base station is above a threshold, and based on the spectral efficiency of the first set of signals between the base station and the first UE being above the threshold, utilizing beamforming for a set of control signals between the first UE and the base station.

A second aspect of the present disclosure is directed to a method for selecting user equipment (UE) candidates for control signaling using beamformed signals. The method comprises determining a spectral efficiency of a first set of signals between a first UE and a base station and a second set of signals between a second UE and the base station in a telecommunications network. The first and second sets of signals comprise the beamformed signals transmitted from the base station using MU-MIMO. The method further comprises determining that the spectral efficiencies of the first and second sets of signals are above a threshold, and based on the spectral efficiencies of the first and second sets of signals are above a threshold, pairing the first UE and the second UE together for the control signaling using the MU-MIMO.

Another aspect of the present disclosure is directed to system for selecting user equipment (UE) candidates for control signaling using beamformed signals. The system comprises a first UE and a base station configured to wirelessly communicate with the first UE. The base station is configured to determine a spectral efficiency of a first set of signals between the first UE and a base station in a telecommunications network, determine that the spectral efficiency of the first set of signals between the first UE and the base station is above a threshold, and utilizing beamforming for a set of control signals between the first UE and the base station based on the spectral efficiency of the first set of signals between the base station and the first UE being above the threshold.

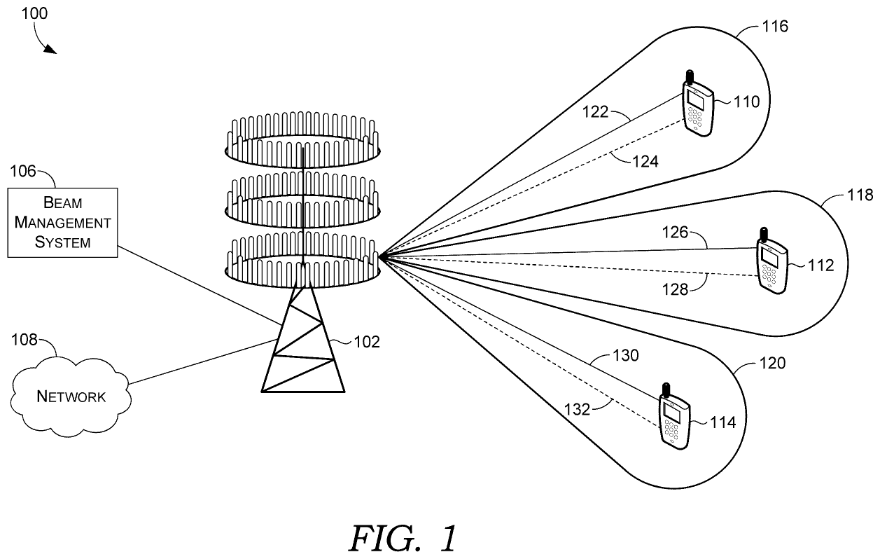

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

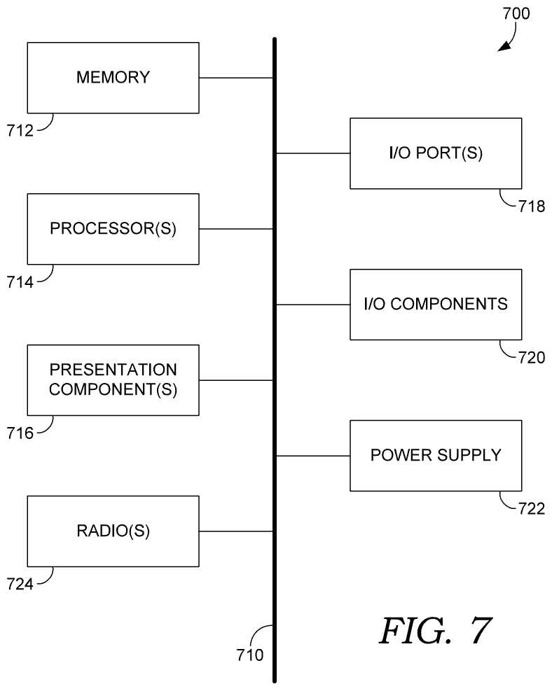

A network cell may comprise a base station to facilitate wireless communication between a communications device within the network cell, such as exemplary computing device 700 described with respect to FIG. 7, and a network. As shown in FIG. 1, communications devices include UE 110, UE 112, and UE 114. In the network environment 100, UE 110, UE 112, and UE 114 may communicate with other devices, such as mobile devices, servers, etc. UE 110, UE 112, and UE 114 may take on a variety of forms, such as a personal computer, a laptop computer, a tablet, a netbook, a mobile phone, a Smart phone, a personal digital assistant, an Internet of Things (IoT) device, an unmanned drone (aerial or terrestrial), a connected device in a vehicle, or any other device capable of communicating with other devices. For example, UE 110, UE 112, and UE 114 may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, UE 110, UE 112, and UE 114 may comprise a wireless or mobile device with which a wireless telecommunication network(s) can be utilized for communication (e.g., voice and/or data communication). In this regard, UE 110, UE 112, and UE 114 can be any mobile computing device that communicates by way of, for example, a 5G network.

UE 110, UE 112, and UE 114 may utilize network 108 to communicate with other computing devices (e.g., mobile device(s), a server(s), a personal computer(s), etc.). In A embodiments, network 108 is a telecommunications network, or a portion thereof. telecommunications network might include an array of devices or components, some of which are not shown so as to not obscure more relevant aspects of the invention. Components such as terminals, links, and nodes (as well as other components) may provide connectivity in some embodiments. Network 108 may include multiple networks, as well as being a network of networks, but is shown in more simple form so as to not obscure other aspects of the present disclosure. Network 108 may be part of a telecommunications network that connects subscribers to their immediate service provider. In embodiments, network 108 is associated with a telecommunications provider that provides services to user devices, such as UE 110, UE 112, and UE 114. For example, network 108 may provide voice services to user devices or corresponding users that are registered or subscribed to utilize the services provided by a telecommunications provider. It is contemplated that network 108 can be any communication network providing voice and/or data service(s), such as, for example, a 1x circuit voice, a 3G network (e.g., CDMA, CDMA1000, WCDMA, GSM, UMTS), a 4G network (WiMAX, LTE, HSDPA), a 5G network, a 6G network, or the like.

UE 110, UE 112, and UE 114 are each depicted within a beamform (respectively beamforms 116, 118, and 120). Each of UE 110, UE 112, and UE 114 also has a PDSCH signal (signals 122, 126, and 130 respectively) and a PDCCH signal (signals 124, 128, and 132). As described in more detail herein, the PDSCH signals generally transmit data to the UEs, while the PDCCH signals generally transmit control signals to the UEs. UE 110, UE 112, and UE 114 may be paired together for MU-MIMO purposes, as more fully disclosed herein.

The network environment 100 may include a database (not shown). The database may be similar to the memory component 712 in FIG. 7 and can be any type of medium that is capable of storing information. The database can be any collection of records (e.g., network or device information). In one embodiment, the database includes a set of embodied computer-executable instructions that, when executed, facilitate various aspects disclosed herein. These embodied instructions will variously be referred to as “instructions” or an “application” for short.

As previously mentioned, UE 110, UE 112, and UE 114 may communicate with other devices by using a base station, such as base station 102 (also termed “cell site”). In embodiments, base station 102 is a wireless communications station that is installed at a fixed location, such as at a radio tower, as illustrated in FIG. 1. The radio tower may be a tall structure designed to support one or more antennas for telecommunications and/or broadcasting. In other embodiments, base station 102 is a mobile base station. The base station 102 may be an MMU and include gNodeB for mMIMO/5G communications via network 108. In this way, the base station 102 can facilitate wireless communication between UE 110, UE 112, and UE 114 and network 108.

As stated, the base station 102 may include a radio (not shown) or a remote radio head (RRH) that generally communicates with one or more antennas associated with the base station 102. In this regard, the radio is used to transmit signals or data to an antenna associated with the base station 102 and receive signals or data from the antenna. Communications between the radio and the antenna can occur using any number of physical paths. A physical path, as used herein, refers to a path used for transmitting signals or data. As such, a physical path may be referred to as a radio frequency (RF) path, a coaxial cable path, cable path, or the like.

The antenna is used for telecommunications. Generally, the antenna may be an electrical device that converts electric power into radio waves and converts radio waves into electric power. The antenna is typically positioned at or near the top of the radio tower as illustrated in FIG. 1. Such an installation location, however, is not intended to limit the scope of embodiments of the present invention. The radio associated with the base station 102 may include at least one transceiver configured to receive and transmit signals or data.

Continuing, the network environment 100 may further include a beam management system 106. The beam management system 106 may be configured to, among other things, identify one or more UEs as candidates for control signaling using beamforming, and in some instances, MU-MIMO, in accordance with the present disclosure. Though beam management system 106 is illustrated as a component connected to base station 102 in FIG. 1, it may be integrated with base station 102, a standalone device (e.g., a server having one or more processors), a component of one of the UEs, a service provided via the network 108, and/or may be remotely located.

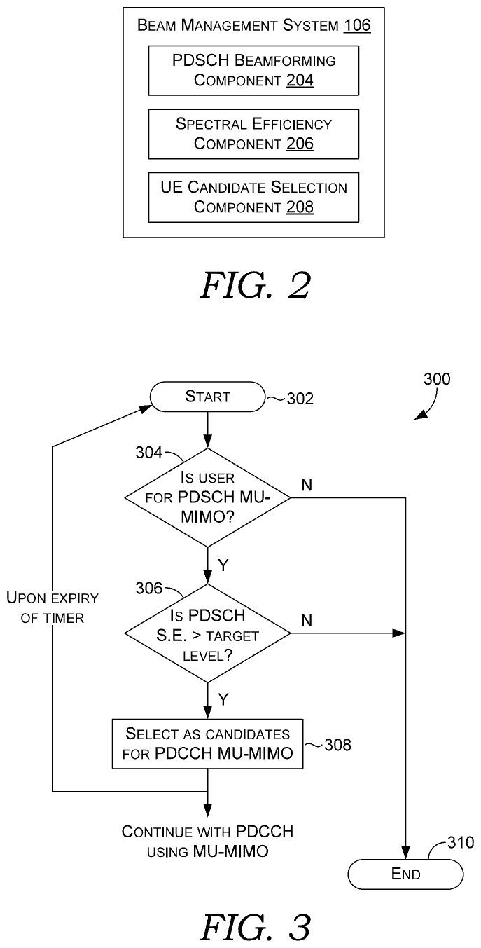

Referring now to FIG. 2, the beam management system 106 may include, among other things, a PDSCH beamforming component 204, a spectral efficiency component 206, and a UE candidate selection component 208. The beam management system 202 may receive, among other things, data from user devices, such as UE 110, UE 112, and UE 114 of FIG. 1, within a network cell associated with a particular base station 102, or from the base station 102 itself. For example, the beam management system 106 may receive a signal from UE 110, UE 112, or UE 114 to the base station 102 or a signal from the base station 102 to UE 110, UE 112, or UE 114.

PDSCH beamforming component 204 is generally responsible for determining whether a particular UE attached to the base station is currently scheduled for PDSCH beamforming, such as MU-MIMO transmissions. The spectral efficiency component 206 is generally responsible for determining whether, for a UE that is currently scheduled for PDSCH MU-MIMO transmissions, the spectral efficiency of the PDSCH is above a predetermined threshold. The UE candidate selection component 208 analyzes the UEs that are currently scheduled for PDSCH MU-MIMO transmissions and the spectral efficiencies and determines whether a UE should be a candidate for PDCCH MU-MIMO transmissions. In one aspect, the spectral efficiency is computed by multiplying the number of MIMO layers by the product of the modulation order and code rate. For example, for 4×4 MIMO layers and MCS or 10 (16 QAM, code rate 520/1024), spectral efficiency would be 4×(4×520/1024)=8.125.

Turning to FIG. 3, a diagram 300 is provided of a flow chart for selecting target users for PDCCH MU-MIMO among RRC connected users. Initially, the flow chart starts at block 302. At block 304, it is determined whether a UE is currently scheduled for PDSCH MU-MIMO. If yes, we proceed to block 306. If no, the flow chart ends at block 310, as the UE would need to be scheduled for PDSCH MU-MIMO to continue through the flow chart. At block 306, it is determined whether the PDSCH spectral efficiency is greater than a threshold. If yes, we continue to block 308. If no, the flow chart ends at block 310, as the PDSCH spectral efficiency would need to be greater than a threshold to continue through the flow chart. At block 308, UE candidates are selected for PDCCH MU-MIMO based on answers to blocks 304 and 306. Once a UE is selected, PDCCH using MU-MIMO resumes until expiration of a timer, at which time the flow chart begins again at block 302.

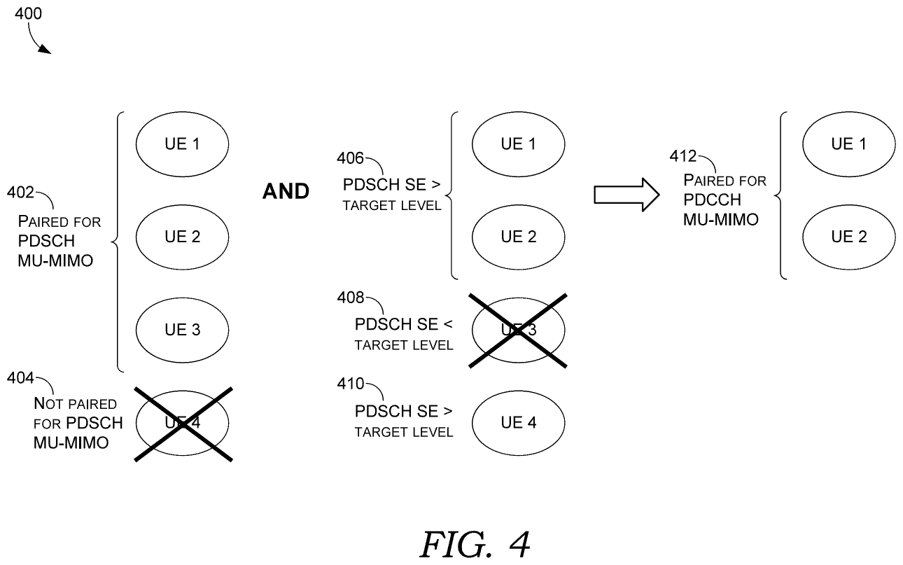

FIG. 4 depicts UE selection for PDCCH MU-MIMO pairing, in accordance with aspects herein, and shown as numeral 400. Numeral 402 represents UE 1, UE 2, and UE 3 that are paired for PDSCH MU-MIMO. Numeral 404 represents UE 4, which is crossed out, indicating that it is not paired for PDSCH MU-MIMO, such that UE 4 would not be eligible for PDCCH MU-MIMO. Numeral 406 represents UE 1 and UE 2, which has a PDSCH spectral efficiency that has been found to be greater than a target level. Numeral 408 represents UE 3, which is crossed out indicating that the PDSCH spectral efficiency is below the target level, such that UE 3 would not be eligible for PDCCH MU-MIMO. Numeral 410 represents UE 4, whose PDSCH spectral efficiency has been found to be greater than a target level. The last column in FIG. 4 illustrates numeral 412, which represents UE 1 and UE 2, which have been paired for PDCCH MU-MIMO based on these UEs being both currently scheduled for PDSCH MU-MIMO and the PDSCH spectral efficiencies being above a threshold.

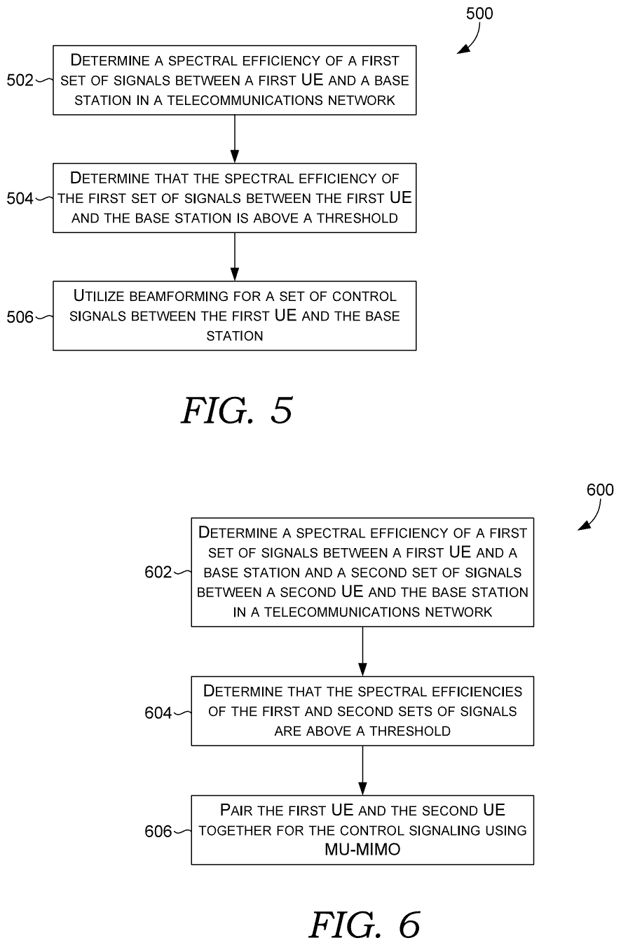

FIG. 5 depicts a flow diagram of a method 500 for selecting UE candidates for control signaling using beamformed signals, in accordance with aspects herein. At block 502, a spectral efficiency of a first set of signals between a first UE and a base station in a telecommunications network is determined. The first set of signals comprises one or more data transmissions or synchronization signaling. More specifically, the first set of signals may correspond to a downlink physical channel that delivers data from the base station to the first

UE. In one aspect, the first set of signals is PDSCH signaling, which transmits data from the network to the UE. Additionally, the first set of signals may comprise beamformed signals (e.g., MU-MIMO) transmitted from the base station. In one aspect, it may also be determined that the first UE receives data signals, such as PDSCH, using beamforming, such as MU-MIMO. At block 504, it is determined that the spectral efficiency of the first set of signals between the first UE and the base station is above a threshold. At block 506, beamforming is utilized for a set of control signals between the first UE and the base station.

In one aspect, a spectral efficiency of a second set of signals between a second UE and the base station is determined. It is then determined that the spectral efficiency of the second set of signals is above a threshold. The first UE and the second UE may then be paired together for purposes of control signaling using beamforming, or in one aspect, PDCCH using MU-MIMO. In scenarios when MU-MIMO is used for PDCCH, the UEs are paired together, as they are with PDSCH with MU-MIMO.

FIG. 6 depicts another flow diagram of a method 600 for selecting UE candidates for control signaling using beamformed signals, in accordance with aspects herein. At block 602, a spectral efficiencies of a first set of signals between a first UE and a base station and a second set of signals between a second UE and the base station in a telecommunications network are determined. Additionally, in some aspects, prior to determining the spectral efficiencies of the first and second sets of signals, it may be determined that the first UE and the second UE are paired together for beamforming for these sets of signals. For instance, if the first and second sets of signals are PDSCH using MU-MIMO, it may be determined whether the first and second UEs are paired together for the MU-MIMO. If yes, the spectral efficiencies of the PDSCH transmissions may be determined shown at block 602. The first and second sets of signals may comprise one or more data transmissions or synchronization signaling. At block 604, it is determined that the spectral efficiencies of the first and second sets of signals are above a threshold. As a result, at block 606, the first UE and the second UE are paired together for the control signaling using MU-MIMO.

Embodiments of the technology described herein may be embodied as, among other things, a method, a system, or a computer-program product. Accordingly, the embodiments may take the form of a hardware embodiment, or an embodiment combining software and hardware. The present technology may take the form of a computer-program product that includes computer-useable instructions embodied on one or more computer-readable media. The present technology may further be implemented as hard-coded into the mechanical design of network components and/or may be built into a broadcast cell or central server.

Computer-readable media includes both volatile and non-volatile, removable and non-removable media, and contemplate media readable by a database, a switch, and/or various other network devices. Network switches, routers, and related components are conventional in nature, as are methods of communicating with the same. By way of example, and not limitation, computer-readable media may comprise computer storage media and/or non-transitory communications media.

Computer storage media, or machine-readable media, may include media implemented in any method or technology for storing information. Examples of stored information include computer-useable instructions, data structures, program modules, and other data representations. Computer storage media may include, but are not limited to, RAM, ROM, EEPROM, flash memory or other memory technology, CD-ROM, digital versatile discs (DVD), holographic media or other optical disc storage, magnetic cassettes, magnetic tape, magnetic disk storage, and/or other magnetic storage devices. These memory components may store data momentarily, temporarily, and/or permanently, and are not limited to the examples provided.

Communications media typically store computer-useable instructions-including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Referring to FIG. 7, a block diagram of an exemplary computing device 700 suitable for use in implementations of the technology described herein is provided. In particular, the exemplary computer environment is shown and designated generally as computing device 700. Computing device 700 is but one example of a suitable computing environment and is not intended to suggest any limitation as to the scope of use or functionality of the invention. Neither should computing device 700 be interpreted as having any dependency or requirement relating to any one or combination of components illustrated. It should be noted that although some components in FIG. 7 are shown in the singular, they may be plural. For example, the computing device 700 might include multiple processors or multiple radios. In aspects, the computing device 700 may be a UE/WCD, or other user device, capable of two-way wireless communications with an access point. Some non-limiting examples of the computing device 700 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 7, computing device 700 includes a bus 710 that directly or indirectly couples various components together, including memory 712, processor(s) 714, presentation component(s) 716 (if applicable), radio(s) 724, input/output (I/O) port(s) 718, input/output (I/O) component(s) 720, and power supply(s) 722. Although the components of FIG. 7 are shown with lines for the sake of clarity, in reality, delineating various components is not so clear, and metaphorically, the lines would more accurately be grey and fuzzy. For example, one may consider a presentation component such as a display device to be one of I/O components 720. Also, processors, such as one or more processors 714, have memory. The present disclosure hereof recognizes that such is the nature of the art, and reiterates that FIG. 7 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 712 may take the form of memory components described herein. Thus, further elaboration will not be provided here, but it should be noted that memory 712 may include any type of tangible medium that is capable of storing information, such as a database. A database may be any collection of records, data, and/or information. In one embodiment, memory 712 may include a set of embodied computer-executable instructions that, when executed, facilitate various functions or elements disclosed herein. These embodied instructions will variously be referred to as “instructions” or an “application” for short.

Processor 714 may actually be multiple processors that receive instructions and process them accordingly. Presentation component 716 may include a display, a speaker, and/or other components that may present information (e.g., a display, a screen, a lamp (LED), a graphical user interface (GUI), and/or even lighted keyboards) through visual, auditory, and/or other tactile cues.

Radio 724 represents a radio that facilitates communication with a wireless telecommunications network. Illustrative wireless telecommunications technologies include CDMA, GPRS, TDMA, GSM, and the like. Radio 724 might additionally or alternatively facilitate other types of wireless communications including Wi-Fi, WiMAX, LTE, 3G, 4G, LTE, mMIMO/5G, NR, 6G, VOLTE, or other VoIP communications. As can be appreciated, in various embodiments, radio 724 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 718 may take a variety of forms. Exemplary I/O ports may include a USB jack, a stereo jack, an infrared port, a firewire port, other proprietary communications ports, and the like. Input/output (I/O) components 720 may comprise keyboards, microphones, speakers, touchscreens, and/or any other item usable to directly or indirectly input data into the computing device 700.

Power supply 722 may include batteries, fuel cells, and/or any other component that may act as a power source to supply power to the computing device 700 or to other network components, including through one or more electrical connections or couplings. Power supply 722 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A method for selecting user equipment (UE) candidates for control signaling using beamformed signals, the method comprising:
determining a spectral efficiency of a first set of signals between a first UE and a base station in a telecommunications network;
determining that the spectral efficiency of the first set of signals between the first UE and the base station is above a threshold; and
based on the spectral efficiency of the first set of signals between the base station and the first UE being above the threshold, utilizing beamforming for a set of control signals between the first UE and the base station.

2. The method of claim 1, wherein the first set of signals comprises one or more of data transmissions or synchronization signaling.

3. The method of claim 1, wherein the first set of signals comprises beamformed signals transmitted from the base station.

4. The method of claim 1, further comprising:
determining a spectral efficiency of a second set of signals between a second UE and the base station in the telecommunications network; and
determining that the spectral efficiency of the second set of signals between the second UE and the base station is above the threshold.

5. The method of claim 4, further comprising pairing the first UE and the second UE together for the control signaling using the beamforming.

6. The method of claim 1, wherein the beamforming is multiple-user multiple-input multiple-output (MU-MIMO).

7. The method of claim 4, further comprising prior to determining the spectral efficiency of the first set of signals and the second set of signals, determining that the first UE and the second UE are paired together for the beamforming of the first and second sets of signals.

8. The method of claim 1, wherein the first set of signals corresponds to a downlink physical channel that delivers data from the base station to the first UE.

9. A method for selecting user equipment (UE) candidates for control signaling using beamformed signals, the method comprising:
determining a spectral efficiency of a first set of signals between a first UE and a base station and a second set of signals between a second UE and the base station in a telecommunications network, wherein the first and second sets of signals comprise the beamformed signals transmitted from the base station using multiple-user multiple-input multiple-output (MU-MIMO);
determining that the spectral efficiencies of the first and second sets of signals are above a threshold; and
based on the spectral efficiencies of the first and second sets of signals are above a threshold, pairing the first UE and the second UE together for the control signaling using the MU-MIMO.

10. The method of claim 9, further comprising prior to determining the spectral efficiency of the first set of signals and the second set of signals, determining that the first UE and the second UE are paired together for the beamforming of the first and second sets of signals.

11. The method of claim 9, wherein the first set of signals corresponds to a downlink physical channel that delivers data from the base station to the first UE.

12. The method of claim 9, wherein the first set of signals comprises one or more of data transmissions or synchronization signaling.

13. A system for selecting user equipment (UE) candidates for control signaling using beamformed signals, the system comprising:
a first UE; and
a base station configured to wirelessly communicate with the first UE, wherein the base station is configured to:
determine a spectral efficiency of a first set of signals between the first UE and a base station in a telecommunications network;
determine that the spectral efficiency of the first set of signals between the first UE and the base station is above a threshold; and
utilizing beamforming for a set of control signals between the first UE and the base station based on the spectral efficiency of the first set of signals between the base station and the first UE being above the threshold.

14. The system of claim 13, wherein the first set of signals comprises one or more of data transmissions or synchronization signaling.

15. The system of claim 13, wherein the first set of signals comprises the beamformed signals transmitted from the base station.

16. The system of claim 13, further comprising:
determining a spectral efficiency of a second set of signals between a second UE and the base station in the telecommunications network; and
determining that the spectral efficiency of the second set of signals between the second UE and the base station is above the threshold.

17. The system of claim 16, further comprising pairing the first UE and the second UE together for the control signaling using the beamforming.

18. The system of claim 13, wherein the beamforming is multiple-user multiple-input multiple-output (MU-MIMO).

19. The system of claim 16, further comprising prior to determining the spectral efficiency of the first set of signals and the second set of signals, determining that the first UE and the second UE are paired together for the beamforming of the first and second sets of signals.

20. The system of claim 13, wherein the first set of signals corresponds to a downlink physical channel that delivers data from the base station to the first UE.
